(19) United States
(12) Patent Application Publication
(10) Pub. No.: US 2006/0294344 A1
(43) Pub. Date: Dec. 28, 2006

(54) Computer processor pipeline with shadow registers for context switching, and method

(75) Inventors: Yi-Fan Hsu, San Francisco, CA (US); Govind Kizhepat, Los Altos, CA (US)

Correspondence Address: ELLIOT FURMAN, 15 WEST 81ST STREET #11J, NEW YORK, NY, 10024, US

(73) Assignee: Universal Network Machines, Inc.

(21) Appl. No.: 11/169,138

(22) Filed: Jun. 28, 2005

(51) Int. Cl. G06F 9/44

(52) U.S. Cl. 712/228

(57) ABSTRACT

A computer processor pipeline comprises a register file and a plurality of pipe stages connected to the register file. Each pipe stage comprises a working register and a shadow register. The working registers of the plurality of pipe stages are connected together to form a working pipe. The shadow registers of the plurality of pipe stages are connected together to form a shadow register chain. On a context switch event, context data associated with a process in the working pipe are swapped with context data associated with a different process stored in the shadow register chain. The data are swapped within one clock cycle. The computer processor pipeline also includes a context cache connected to the shadow register chain and register file for storing additional contexts and for moving the context data in and out of the shadow register chain and register file.

### BACKGROUND

Most modern computer processors, or central processing units (CPUs), employ a pipelined architecture in which the data execution path is divided into multiple stages. On each clock cycle, each stage performs an operation or executes an instruction on the data stored at that stage, and then passes the data to the next stage for more processing. New data may be loaded into the pipeline while the older data is still in the pipeline. In this manner, a pipeline architecture facilitates the use of higher clock frequencies, and increases the throughput of the processor. A pipeline architecture does however increase the latency when performing data operations since data must pass through several stages before the operation is complete.

A basic pipeline architecture comprises a register file, a set of registers connected together and to the register file, and other logic such as an arithmetic logic unit (ALU) for performing bitwise and mathematical operation on data as it passes between stages. In one example of an instruction performed by a pipelined processor, the values of two integers are added and stored. To execute the instruction r1<−r2+r3, the following is executed at each stage of an exemplary processor pipeline:

RA: addresses of r2 and r3 are given to the register file.

RL: the values of r2 and r3 are looked up by the register file.

BY: the values of r2 and r3 are latched in two BY stage registers.

EX: the ALU performs the addition and the sum, r1, is latched in an EX register.

WB: The sum is written back into the register file and into a WB stage register.

Computer processor pipelines may have many more stages than those in the above example. However, the fundamental concept of pipelining remains the same, and the more stages in the pipeline, the greater the latency.

Software is more accurately referred to as a process. A process is comprised of a multiplicity of instructions which are executed in the pipeline of the processor as a series of simpler instructions. Each process has associated with it a context. A context is all of the data and register values that completely describe the process's current state of execution.

Computers execute many processes. The action of switching between processes is called context switching. While processes seemingly run in parallel, at the processor pipeline level, one process is executed while the others are halted. Even in processors with more than one pipeline, there are always processes that must be halted in order to run other processes. Processes, for the most part, are therefore run in series and switched between each other at very high speeds, providing the illusion of simultaneous operation.

Processors switch between processes on a context switch signal. A context switch signal is generated on an exception, or when a running process requests a context switch, or when the context switch signal is explicitly generated by an instruction, such as a return from exception (RFE) instruction. Examples of exceptions are, the time allotted a process has expired, a more system critical process must be run, the user started another process, an error occurred, a currently running process launches a new process, and the like. When a context switch signal is received, the context information of the currently executing process must be stored in memory, the context information of the next process to be executed read from memory, and then loaded into the pipeline.

Context switching is very costly in terms of processor throughput and efficiency. Many clock cycles are wasted in saving a current context to memory and loading the next context from memory and into the processor pipeline. The longer the pipeline, the more clock cycles wasted; a longer pipeline contains more data, and thus requires more clock cycles to save and load the data on each context switch.

One common way to help reduce context switching penalties is to place a high speed memory, such as SRAM, on the CPU itself so that at least some context data can be stored locally without having to store it on comparatively slow off-chip DRAM. This, however, is far from optimal since it typically requires at least one clock cycle for the data at each pipeline stage register to be written to or read from SRAM, plus the clock cycles needed to set-up the reading or writing. Another common way to help reduce context switching penalties is to use parallel register files, or larger register files, able to store context data associated with more than one process. By storing more than one context, clock cycles can be saved on a context switch simply by pointing to the register file, or sets of registers in the register file, containing the next process.

In both the SRAM and register file solutions, the problem remains that longer pipelines require more clock cycles to save and restore context data when an exception occurs. For example, for a pipeline having 15 stages, it will take at least 15 clock cycles, plus set-up cycles, to write the current process to memory, and then at least another 15 clock cycles, plus set-up cycles, to read the next process from memory. All processes are effectively halted during this time, causing the overall processor performance to be reduced.

Thus, the speed at which a processor context switches is fundamentally limited by the hardware itself, the length of the pipeline, the need to save and load data at each level of the entire pipeline, and the limitation that context data is stored in a memory that requires many clock cycles to read from and write to.

Thus a need presently exists for a system and method for almost instantaneous context switching without the penalties incurred by prior art solutions.

### SUMMARY

The present invention provides a computer processor pipeline with shadow registers for context switching, and method. A register file is connected to a plurality of pipe stages. The register file stores working data associated with a running process, and shadow data associated with a halted process. Each of the pipe stages comprises a working register, a shadow register, and a means for swapping data between the working register and the shadow register. The working registers are connected together to form a working pipe. The shadow registers are connected together to form a shadow register chain. The working pipe receives and stores working data associated with a process from the register file. The working data is processed in the working pipe, thereby executing the process. The shadow register chain stores shadow data associated with the halted process. When a context switch event occurs, the working data are swapped with the shadow data. The swap is completed within one clock cycle. Upon swapping, the process that was running prior to the context switch event is halted and stored in the shadow chain, and the context of the halted process that was swapped to the working pipe resumes execution. A pointer selects between the working data and shadow data in the register file. A context cache is connected to the shadow register chain and the register file. Data stored in the shadow register chain and register file may be written to the context cache, and data stored in the context cache may be read from the context cache and written to the shadow register chain and register file. Reading between the context cache, shadow register chain, and register file occurs while a process is running in the working pipe. Thus, on a context switch event, the context of the next process is fully stored in the shadow register chain and register file, and upon the context switch signal, it can be fully restored to the working pipe, and execution resumed, within one clock cycle. The context cache also communicates with a memory, such as a system memory, an L1 cache, or an L2 cache. Additional logic such as multiplexers, arithmetic logic units, data caches, and the like may be connected between pipe stages.

The foregoing paragraph has been provided by way of general introduction, and it should not be used to narrow the scope of the following claims. The preferred embodiments will now be described with reference to the attached drawings.

### BRIEF DESCRIPTION OF THE DRAWINGS

FIG. 1 is a computer processor pipeline with shadow registers of the present invention.

FIG. 2 is a working register/shadow register swapping circuit for each pipe stage of the computer processor pipeline.

FIG. 3 is a computer processor pipeline with shadow registers and including an arithmetic logic unit of the present invention.

FIG. 4 is a context switching method of the present invention.

### DETAILED DESCRIPTION OF THE PRESENTLY PREFERRED EMBODIMENTS

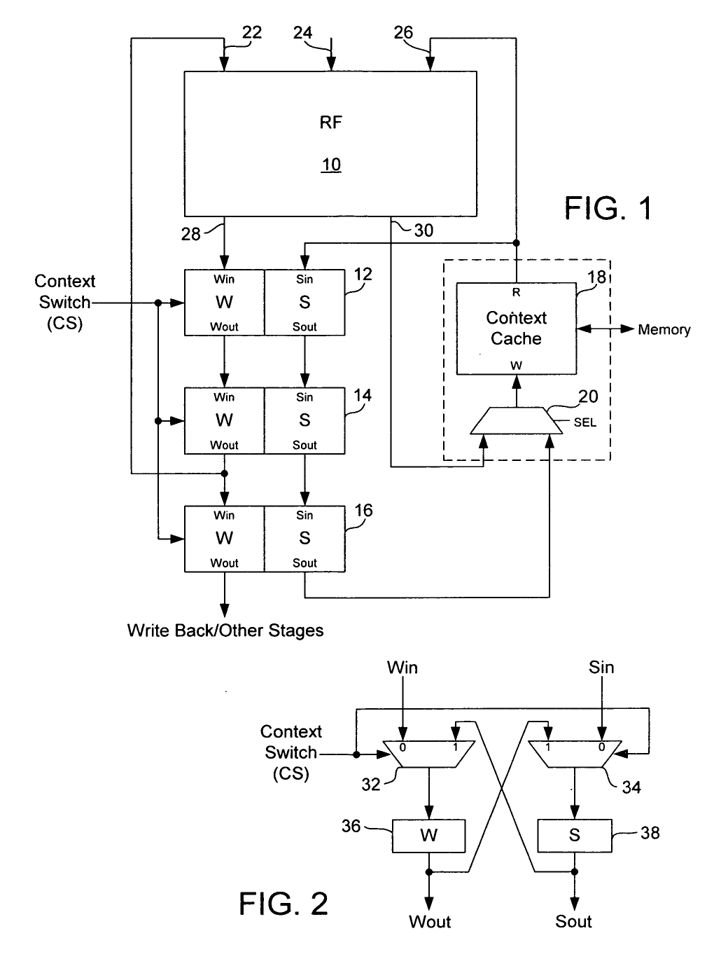

FIG. 1 shows a computer processor pipeline of the present invention. A register file 10 provides data to the pipe comprising stages 12, 14 and 16. The register file 10 comprises a plurality of write ports, 22, 24, and 26, and a plurality of read ports 28 and 30. There may be more or less read and write ports than those shown. In one example, the register file is 128×64bits and has 3 write ports and 5 read ports.

The registers of the register file comprise a plurality of register sets. Each register set may store data associated with a different process. The register set storing data for the currently running process is designated the working register file register set. A register set storing data for another process that is not running is designated a shadow register file register set. There may be one or more shadow register file register sets.

Any of the register sets can be selectively connected to any of the write ports and any of the read ports. A pointer, for example, selects which register set of the plurality of register sets is the working register file set. In this way, the data set for the next process can be quickly switched to simply by modifying a pointer value. Pointer values can be modified in one clock cycle, and it should be clear to those of ordinary skill in the art how to build a register file such as the one described.

The pipe comprising pipe stages 12, 14 and 16 is connected to the register file 10. Each pipe stage comprises a working register W, and a shadow register S. Each stage has a working input and output, Win and Wout, and a shadow input and output, Sin and Sout. The working registers of each stage are connected together to form a working pipe. In FIG. 1, the working pipe comprises the W portion of each stage 12, 14, and 16. Win of 12 is connected to register file read port 28. Wout of stage 12 is connected to Win of stage 14, and Wout of stage 14 is connected to Win of stage 16. While only three stages are shown, those skilled in the art will readily appreciate that more stages can be added.

Each pipe stage also comprises a Context Switch (CS) input. The CS input receives a switch signal when an context switch event occurs. A context switch event is a hardware exception, a software exception, a context switch triggered by a running process, or an explicit instruction, such as a return from exception (RFE) instruction. It is well understood how to create such signals upon the occurrence of a context switch event. When the CS signal is received, the data contents of the working register W and the shadow register S at each stage are swapped with each other. Concurrently, a different register file set is selected as the working register file register set.

In one example, the working pipe is operating on data, corresponding to a first process. On each clock cycle, the data moves down the pipe from stage 12, to stage 14, to stage 16, and so on, and the register file (the working register file register set) provides more data for the current process to the working pipe at stage 12. When a first context 5 switch event occurs, a CS signal causes the data in W and S to be swapped at each pipe stage. Upon swapping, the data, or context, associated with the first process is stored in the S portion of each stage, and that process is halted. Also, the working register file register set (the register file data for the first process) is switched to the shadow register file register set The data in all stages are swapped simultaneously and in one clock cycle, 10 and therefore a context switch is completed in one clock cycle.

Continuing the example, after the swap effected by the first context switch event, the register file provides new data (from a different register file register set) for a second process to the working pipe. While the second process is executing, the context of the first process remains stored in the shadow pipe, with data in each respective shadow 15 register remaining there. On a second context switch event, the CS signal again causes the data contents of the working pipe (the context associated with the second process) to be swapped with the data stored in the shadow pipe. Concurrently, the shadow register file register set is selected as the new working register file register set.

Recall, the data stored in the shadow pipe and in the shadow register file register 20 set is the context of first process at the time of the first context switch event. Thus, the working pipe is restored with the context associated with the first process and can immediately resume the execution of the first process. As before, the swap occurs in one clock cycle and all stages perform the swap simultaneously, so the entire context switch operation requires only one cycle. Of course, on each context switch event, the register 25 file set corresponding to the process swapped to the working pipe is pointed to as the working resister file register set. It is understood herein that any example or description of context switching and register swapping includes pointing to a corresponding register file set.

FIG. 2 shows the working register/shadow register swapping circuit at each pipe 30 stage of the computer processor pipeline. The swapping circuit comprises a working input Win, a working output Wout, a shadow input Sin, a shadow output Sout, and a CS control input.

Two multiplexers, 32 and 34, are connected to CS. The output of multiplexer 32 is connected to the input of register 36, the working register W. The output of multiplexer 34 is connected to the input of the register 38, the shadow register S. Working register 36 supplies Wout, and shadow register supplies Sout. The active low input of multiplexer 32 in connected to the Win, and the active high input of multiplexer 32 is connected to Sout. The active low input of multiplexer 34 is connected to Sin, and active high input of multiplexer 34 is connected to Wout. In one example the working register W and shadow register W are 64 bits wide and clock-edge triggered.

In operation, when CS is low (0) Win is latched by working registers 36 on each clock cycle. Similarly Sin is latched by shadow register 38 on each clock cycle. When CS is high (1), as is the case on a context switch event, the output of working register 36 is connected to the input of shadow register 38 through multiplexer 34, and the output of shadow register 38 is connected to the input of working register 36 through multiplexer 32. On the next clock cycle, and within exactly one clock cycle, the data stored in W 36 and S 38 are swapped. That is, the S data is moved to W, and the W data is moved to S.

In some instances it may be desirable to prevent Sin from being latched by the shadow register on every clock cycle when CS=0. In those cases the clock to shadow register 38 can be gated. When the clock is gated, the data stored in register 38 remains stored in the register, while Win is latched by working register 36 on each clock cycle. Other techniques that have the equivalent effect as clock gating, such as feeding the output of the S register back to its input, may be used. Clock gating and the like is well understood by those skilled in the art.

Turning back to FIG. 1, the shadow registers S of each stage 12, 14, and 16, are connected to each other in series to form a shadow register chain. Specifically, Sout of stage 12 is connected to Sin of stage 14, and Sout of stage 14 is connected to Sin of stage 16. If the pipeline comprises more stages, the additional S portions of each stage are similarly connected.

The computer processor pipeline also includes a context cache 18 having a read port and a write port. One shadow register of the chain, Sin of stage 12, is connected to the read port of context cache 18, and one shadow register of the chain, Sout of stage 16, is connected to the write port of the context cache 18 through multiplexer 20, or an equivalent switching means. The context cache also includes an interface to a memory, such as a system memory, or a CPU cache, such as an L1 cache, or an L2 cache. The context cache is a high speed memory such as SRAM. For example, the context cache may be 12kbytes in size, with a 64 bit data bus, and operable to read or write 64 bits on every clock cycle. While the context cache is shown as a dedicated cache, it may be a shared cache such as an L1 cache, an L2 cache, or another type of cache, commonly built into CPUs.

Multiplexer 20, or an equivalent switching means, also connects read port 30 of the register file 10 to the context cache 18. This allows the context cache to store data from the register file. Depending on the specific processor pipeline requirements, such functionality may be considered unnecessary, in which case multiplexer 20 can be eliminated and the shadow register chain can be connected directly to the write port of the context cache. Multiplexer 20 is controlled by signal SEL which is a control signal managed by the CPU, and is incidental to the present invention. Such control signals are well understood in the art. Also, the context cache may include multiple write ports, and the multiplexer may be included as part of the context cache, enabling multiple write ports, as denoted by the dotted line of FIG. I enclosing context cache 18 and multiplexer 20.

The context cache, in conjunction with the shadow register chain, stores multiple contexts, and loads contexts into the shadow registers. The context cache also, in conjunction with the register file, stores multiple contexts, and loads contexts into the register file register sets. So, for a particular context, the context cache stores all of the data in the shadow register chain and all of the data in the shadow register file register set. Recall, on a CS, the context from a process can be restored to the working pipe within one clock cycle, and the shadow register file register set can be made the working register file register set within one clock cycle.

So, in one example, process 1 is executing in the working pipe (and is the working register file register set), process 2 is stored in the shadow register chain (and in the shadow register file register set), and the context cache stores the contexts of four more processes, processes 3, 4, 5, and 6. On a context switch event, process 4 will need to be executed. In this case, during the execution of process 1, the contents of the shadow register chain are optionally written to the context cache, and the data associated with the context of process 4 is read from the context cache and loaded into the shadow registers. Also, during the execution of process 1, the contents of the shadow register file register set are written to the context cache, and the data associated with the context of process 4 is read from the context cache and loaded into the shadow register file register set.

On the context switch event, the working and shadow registers are swapped within one clock cycle, and the context of process 1 is stored in the shadow registers. Also, on the context switch event, the shadow register file register set is pointed to as the new working register file register set. After the swap and the selection of the working register file register set, both of which take only one clock cycle and occur in tandem, the execution of process 4 is resumed in the working pipe. The contents of the context cache now comprise processes 3, 5 and 6, and optionally process 2. Note that context state saving and restoration are done by hardware, during the execution of a process.

Since the context cache may be limited in size, and therefore able to store a limited number of contexts, the context cache communicates with memory, such as a system memory, and can accordingly store less often used contexts in the larger system memory.

Outputs of the working pipe may be written back to the register file. Specifically, FIG. 1 shows the output of the working side of pipe stage 14 connected to register file write port 22. Also, the read port of the context cache 18 is connected to the a write port 26 of the register file, thereby allowing context data stored in the context cache to be transferred to the register file 10. Other data, for example data provided by the computer processor, is written to the register through write port 24.

While not explicitly shown in FIG. 1, those skilled in the art will recognize that there may be additional stages, including more than one working register/shadow register instances at each stage, and additional logic in the processor pipeline, without departing from the scope of the present invention. For example, additional logic, such as an arithmetic logic unit (ALU) may be situated between stages. Logic such as multiplexers may also be located, for example, between the register file and the first pipe stage, allowing the working pipe to be provided with data from the register file, or from different sources such as, other caches, other register files, other read ports of the register file, other memory, feedback from other stages of the working pipeline, and data from other parts of the computer processor. Also, the working pipe may include additional caches, such as a data cache located between stages. Data caches and their use in pipelines are well understood in the art.

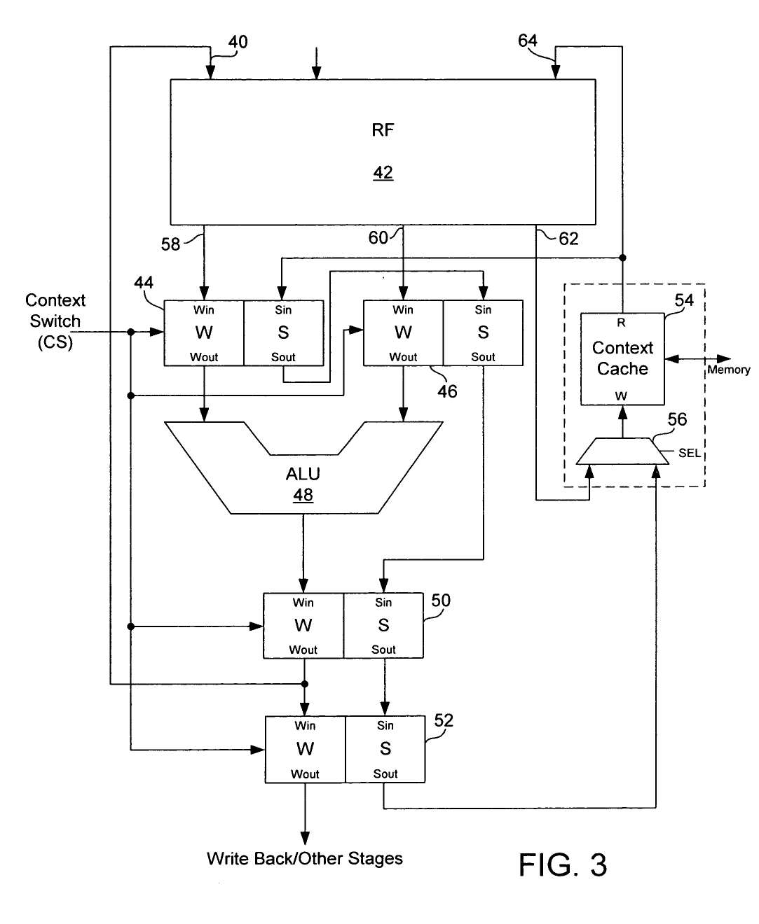

FIG. 3 is a computer processor pipeline with shadow registers, including some of the additional logic mentioned above. The working pipe is comprised of the W registers of pipe stages 44, 46, 50 and 52. Read ports 58 and 60 of register file 42 provide data to the working side of two parallel BY stages 44 and 46. Arithmetic logic unit (ALU) 48, connected to the working side output of the two BY stage registers 44 and 46, performs a logic or mathematical operation on the data from W registers 44 and 46. The ALU output is connected to the W side of EX stage 50, which latches the results. The results are also written back to register file read write port 40 as well as latched by the W side of WB stage 52.

The shadow register chain comprises S registers of pipe stages 44, 46, 50, and 52. As described above with reference to FIG. 1, the S registers are connected in series with the output of S register 44 connected to the input of S register 46, the output of S register 46 connected to the input of S register 50, and the output of S register 50 connected to the input of S register 52. The input of S register 44 is connected to the read port of context cache 54. The output of S register 52 is connected to the write port of context cache 54 through multiplexer 56, which is also connected to read port 62 of register file 42.

FIG. 3 shows just one of many alternate configuration of the processor pipeline shown in FIG. 1 and described above. Many other configuration are possible. Those skilled in the art will appreciate that regardless of the configuration (that is, regardless of the number of stages, parallel stages, additional logic, and the like), the processor pipelines of FIG. 1 and 3 are fundamentally identical in that they include a working pipe, a shadow register chain, a context cache, and a register file. They are also fundamentally identical in the way in which they context switch, as described in the examples given above with reference to FIG. 1.

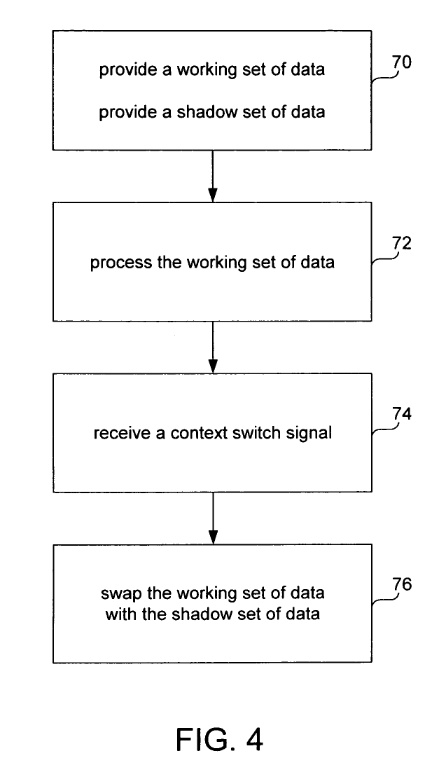

As detailed above, in particular with reference to the examples given with FIG. 1, FIG. 4 show the context switching method. A working set of data is provided, and a shadow set of data is provided (step 70). The working set of data is processed (step 72), during which time additional working data may be provided to the working pipe. A context switch signal is received (step 74), and the working set of data is swapped with the shadow set of data (step 76). The swapping occurs in one clock cycle. The swapping causes the data that was the working set of data to become the shadow set of data, and the data that was the shadow set of data to become the working set of data. After swapping, more data may be provided, the working data can be further processed, and additional swapping performed as context switch signals are received (step 74).

As discussed above, during processing (step 72), context cache data may be read from the context cache and stored in the shadow pipe and the register file, thereby allowing context switching to a context other than the last working context. Also, the shadow set of data in the shadow pipe and in the register file may be written to the context cache during processing.

The data provided to the working pipe is provided from a register file, or if some of the additional logic discussed above includes multiplexers, may be provided from the working pipe itself by tapping the output of various pipe stages and feeding those outputs back to the working pipe. As discussed, some of the working data can be written back to the register file.

Many other variation and embodiments in addition to those discussed are possible. For example, while the computer processor pipelines disclosed thus far have exactly one shadow register for each working register, those skilled in the art will recognize that the circuit of FIG. 2 can be modified to include more than one shadow register for each working register. With such a circuit, the processor pipeline can context switch in one clock between several processes stored in the more than one shadow registers. In order to maximize context switching efficiency, there should be at least one shadow register file register set for each shadow register chain. So, in an embodiment that includes one working pipe, and three shadow chains, the register file would include four register file register sets (one designated the working set and the other three the shadow sets).

Also, in addition to its use in the processor pipeline, the circuit of FIG. 2 may replace other registers in the computer processor, but technically outside of the computer processor pipeline. For example it can be used in place of counter registers, address registers, data registers, system registers, exception registers, mask registers, interrupt registers, timer registers, program counter registers, pointer registers, and the like. For simplicity, these and other registers, including registers that have no specific purpose and are designated for general use, are referred to herein as general purpose registers. Some general purpose registers may store context relevant data. In those instances, it may be preferable to use a working register/shadow register swapping circuit to facilitate single clock context switching on the context switch signal. For example, the circuit of FIG. 2 may be used for the pointer register or registers for selecting the working register file register set described above.

The foregoing detailed description has discussed only a few of the many forms that this invention can take. It is intended that the foregoing detailed description be understood as an illustration of selected forms that the invention can take and not as a definition of the invention. It is only the following claims, including all equivalents, that are intended to define the scope of this invention.

What is claimed is:

1. A context switching method in a computer processor pipeline with shadow registers, the method comprising the steps of:
providing a working set of data;
providing a shadow set of data;
processing the working set of data;
receiving a context switch signal; and
after said receiving, swapping the working set of data with the shadow set of data, wherein said swapping occurs within one clock cycle;
whereby after said swapping the shadow set of data prior to said swapping becomes the working set of data, and the working set of data prior to said swapping becomes the shadow set of data.

2. The method of claim 1 further comprising the steps of, during said processing, reading context cache data from a context cache, and storing the context cache data in a shadow pipe and in a register file, whereby the context cache data stored in the shadow pipe and the register file is the shadow set of data.

3. The method of claim 1 further comprising the step of, during said processing, writing the shadow set of data to a context cache.

4. The method of claim 1 further comprising the step of, after said swapping, providing a new working set of data to the working pipe from a register file.

5. The method of claim 1 further comprising the step of, after said swapping, repeating the steps of providing, processing, receiving, and swapping.

6. A computer processor pipeline with shadow registers for context switching on a context switch signal comprising:
a register file;
a cache connected to said register file;
a working pipe connected to said register file;
a shadow register chain connected to said cache; and
swapping data means for swapping data stored in said working pipe with data stored in said shadow register chain on the context switch signal, wherein the swapping is completed within one clock cycle.

7. The system of claim 6 wherein said register file comprises working register file registers and shadow register file registers.

8. The system of claim 6 wherein said cache comprises a context cache.

9. The system of claim 6 wherein said working pipe comprises additional logic.

10. The system of claim 9 wherein said additional logic comprises an arithmetic logic unit.

11. The system of claim 9 wherein said additional logic comprises a data cache.

12. The system of claim 6 further comprising additional general purpose registers, and swapping data means for swapping data between said general purpose registers on the context switch signal.

13. A computer processor pipeline with shadow registers for context switching on a context switch event comprising:
register file means for providing working data associated with a process and for storing shadow data associated with at least one other process;
working pipe means for storing and processing the working data; and
shadow pipe means for swapping data stored in said working pipe means with shadow data stored in said shadow pipe means on the context switch event, wherein the swapping occurs within one clock cycle, whereby data that was stored in said working pipe means is copied to said shadow pipe means, and whereby data that was stored in said shadow pipe means is copied to said working pipe means.

14. The system of claim 13 further comprising context cache means for reading and writing data to and from said shadow pipe means, and for reading and writing data to and from said register file means.

15. The system of claim 14 further wherein while said working pipe means is processing the working data, said context cache means is providing context cache data to said shadow pipe means and to said register file means, and said shadow pipe means and said register file means are storing the context cache data.

16. The system of claim 14 further wherein the data stored in said shadow pipe means is written to said context cache means, and wherein the shadow data stored in said register file means is written to said context cache means.

17. The system of claim 14 further wherein said context cache means reads and writes data to a memory.

18. The system of claim 13 wherein said working pipe means comprises an arithmetic logic unit.

19. A computer processor pipeline with shadow registers for context switching on an context switch signal comprising:
a register file comprising a plurality of read ports, and a plurality of write ports;
a context cache comprising a read port and a write port, wherein the read port is connected to a write port of said plurality of write ports of said register file;
a multiplexer comprising a first input, a second input, and an output, wherein the first input is connected to a read port of said plurality of read ports of said register file;
a plurality of pipe stages, wherein each of said plurality of pipe stages comprises a working register, a shadow register, and means for swapping data between said working register and said shadow register responsive to the context switch signal;
wherein at least one working register of said plurality of pipe stages is connected to a read port of said plurality of read ports of said register file, wherein at least one other working register of said plurality of pipe stages is connected to a write port of said plurality of write ports of said register file, wherein said working registers of said plurality of pipe stages are connected together to form a working pipe; and
wherein one shadow register of said plurality of pipe stages is connected to the read port of said context cache, wherein each shadow register of said plurality of pipe stages is connected to each other shadow register in series to form a shadow register chain, wherein the last shadow register in the shadow register chain is connected to the second input of said multiplexer.

20. The system of claim 19 wherein said register file further comprises a working register file register set and a shadow register file register set.

21. The system of claim 19 further comprising logic for manipulating data, said logic connected between at least some of said working registers of said plurality of pipe stages.

22. The system of claim 21 wherein said logic comprises an arithmetic logic unit.

23. The system of claim 19 wherein said working registers and said shadow registers are 64 bits wide.

24. The system of claim 19 wherein said context cache comprises SRAM.

25. The system of claim 19 wherein said context cache comprises a CPU cache.

26. The system of claim 19 wherein said context cache is in communication with a memory.
